(19) United States
(12) Patent Application Publication
(10) Pub. No.: US 2005/0007004 A1
(43) Pub. Date: Jan. 13, 2005

(54) Cathode for cathode ray tube

(76) Inventors: Gyeong Sang Lee, Gumi-si (KR); Young Ho Park, Gumi-si (KR)

Correspondence Address: BIRCH STEWART KOLASCH & BIRCH, PO BOX 747, FALLS CHURCH, VA, 22040-0747, US

(21) Appl. No.: 10/882,226

(22) Filed: Jul. 2, 2004

(30) Foreign Application Priority Data
Jul. 10, 2003 (KR) 10-2003-0046733

(51) Int. Cl. H01J 1/20; H01J 19/14

(52) U.S. Cl. 313/446; 313/337; 313/310

(57) ABSTRACT

A cathode for a cathode ray tube with an improved emissivity of electrons is provided. The cathode includes a base metal and an electron emitting material layer containing an alkline earth metal oxide having barium, wherein the base metal has nickel as a main ingredient and contains a reducing metal with a high diffusion speed and a reducing metal with a low diffusion speed; and the electron emitting material layer comprises activating metal(s).

### BACKGROUND OF THE INVENTION

1. Field of the Invention

The present invention relates to a cathode for a cathode ray tube, more particularly, a cathode for a cathode raytube having an improved emissivity of electrons.

2. Discussion of the Related Art

FIG. 1 illustrates the structure of a related art cathode ray tube.

As shown in FIG. 1, the related art cathode ray tube includes a panel 6 having a fluorescent screen formed on an inner surface thereof, a funnel 5 connected to the panel 6, an electron gun 1 housed in the funnel 5 for emitting electron beams, a shadow mask 8 formed on an inside of the panel, having a color selection function, a frame 7 for supporting the shadow mask 8, and a deflection yoke 2 connected to an outside surface of the funnel 5 for deflecting electron beams from side to side.

According to the cathode ray tube with the above structure, when an image signal is input to the electron gun 1, thermal electrons are emitted from a cathode 10 of the electron gun 1, and the electrons emitted from the cathode are accelerated and focused by an applied voltage from respective electrodes.

Further, the electron beams deflected by the deflection yoke 2 in the horizontal and vertical directions are scanned over the inside surface of the panel 6, strike the fluorescent screen, and radiate fluorescent substance, thereby displaying a desired image signal.

As enlargement, high precision, high brightness, and multimedia with a variety of information have been emerged as a new trend for television in recent years, there is a need to develop a cathode 10 with a high current density.

FIG. 2 illustrates the structure of a related art cathode in the cathode ray tube.

As shown in FIG. 2, the related art cathode 10 in the cathode ray tube includes a cylindrical sleeve 12, a base metal 11 formed on an upper portion of the cylindrical sleeve 12, having a very small amount of silicon (Si) and magnesium (Mg) and containing nickel (Ni) as a main ingredient, an electron emitting material layer 13 formed on an upper portion of the base metal 11, having an alline earth metal oxide with barium (Ba) as a main ingredient, and a heater 14 installed inside of the cylindrical sleeve 12, in which the electron emitting material layer 13 is decomposed by heating and emits thermal electrons.

The decomposition procedure associated with the electron emitting material layer 13 by heating is now explained.

At first, the base metal 11 undergoes a high-temperature activation process at about 900-1100° C., and as a result, Si and Mg, the reducing materials included in the base metal 11, are diffused over the interface between the base metal 11 and the electron emitting material layer 13, cause a chemical reaction with a part of the alkaline earth metal oxide, and become semi-conductive.

As a result of the above, the electron emitting material layer 13 becomes an oxygen-deficient semiconductor, and in normal conditions, it can emit electrons with a current density of 0.5-0.8 A/cm² for an extended period of time.

However, a defect of the related art cathode 10 in the cathode ray tube is that a high resistance oxide is produced in or around a base metal input part from the reaction of the electron emitting material layer 13 with the reducing metals included in the base metal 11.

The high resistance oxide puts a limitation on a cathode current and releases joule heat, consequently quickening crystallization of electron emission materials.

In addition, the high resistance oxide obstructs diffusion of the reducing metals contained in the base metal 11 over the electron emitting material layer 13, so an amount of barium being produced is limited and decreased. Therefore, when a high current is fed to the cathode ray tube, the cathode current is rapidly reduced and thus, life span of the cathode 10 is even more shortened.

The above procedures can be expressed by following reaction formulas.
BaCO₃(an electron-emissive carbonate)→BaO(an electron-emissive oxide) +C)₂.
BaO(included in the electron emitting material layer)+Mg(included in the base metal)→Ba+MaO (reactant).
2BaO(included in the electron emitting material layer)+Si(included in the base metal)→2Ba+SiO₂(reactant).
4BaO(included in the electron emitting material layer)+Si(included in the base metal)→2Ba+Ba₂SiO₄(reactant).

To enhance electron emissivity of the cathode under a high current density, Korean Patent Publication No. 1998-015939 has suggested an example of a cathode for use in a cathode ray tube.

The disclosed cathode is composed of a base metal 11 having nickel as a main ingredient, and an electron emitting material layer 13 containing an alkaline earth metal oxide with barium (Ba) as a main ingredient. The base metal 11 contains tungsten (W), and the electron emitting material layer 13 contains lanthanum (La) and magnesium (Mg) oxides. Life span test result of the cathode under a high current density is shown on the graph (A) in FIG. 3.

However, the life span test on the cathode was conducted under the high current density of 4.6 A/cm² for 10,000 hrs. As shown in FIG. 3, the cathode current is reduced by about 16.5% with a lapse of time.

As the test result shows on the graph (A), electron emissivity of the related art cathode under a high current density requires much improvement.

Moreover, to obviate decrease in the cathode current, there is a need to use a very expensive impregnated cathode.

### SUMMARY OF THE INVENTION

An object of the invention is to solve at least the above problems and/or disadvantages and to provide at least the advantages described hereinafter.

Accordingly, one object of the present invention is to solve the foregoing problems by providing a cathode for a cathode ray tube having an improved emissivity of electrons.

The foregoing and other objects and advantages are realized by providing a cathode including a base metal and an electron emitting material layer containing an alkaline earth metal oxide having barium, wherein the base metal has nickel as a main ingredient and contains a reducing metal with a high diffusion speed and a reducing metal with a low diffusion speed; and the electron emitting material layer comprises activating metal(s).

According to another aspect of the invention, a cathode for a cathode ray tube includes a base metal and an electron emitting material layer, wherein the base metal has nickel as a main ingredient and contains a very small amount of a reducing metal; and the electron emitting material layer comprises a barium-containing alline earth metal oxide, at least one of activating metals, and at least one of conductive metals.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a structure of a related art cathode ray tube;

FIG. 2 illustrates a structure of a related art cathode for used in a cathode ray tube;

FIG. 3 graphically shows a test result of a life span of a related art cathode in which the life span test is conducted under a high current density of 4.6 A/cm² for 10,000 hrs;

FIG. 4 illustrates a cathode for a cathode ray tube in accordance with a preferred embodiment of the present invention;

FIG. 5 graphically shows a life span difference between a cathode of the present invention and a related art cathode under a high current density;

FIG. 6 graphically shows how a reducing metal doping onto an electron emitting material layer of a cathode affects life span of the cathode under a high current density; and

FIG. 7 graphically shows test results of life span of a cathode of the present invention, depending on kind of materials doped onto an electron emitting material layer of the cathode.

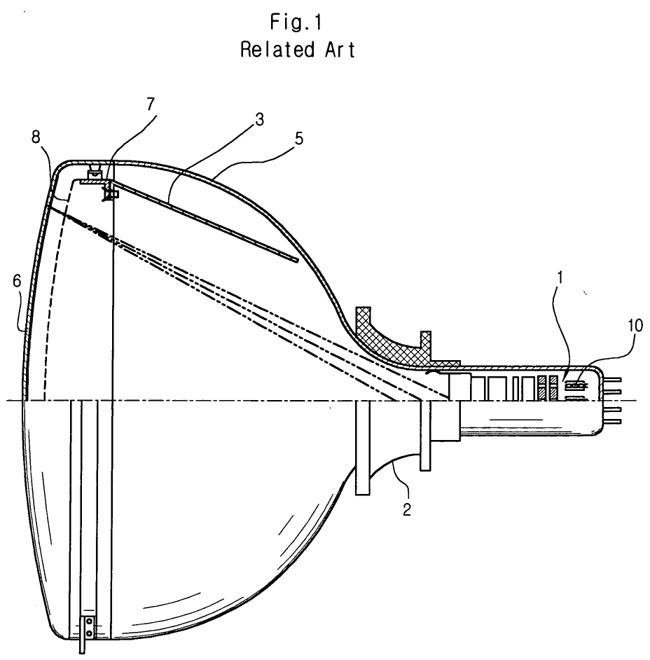

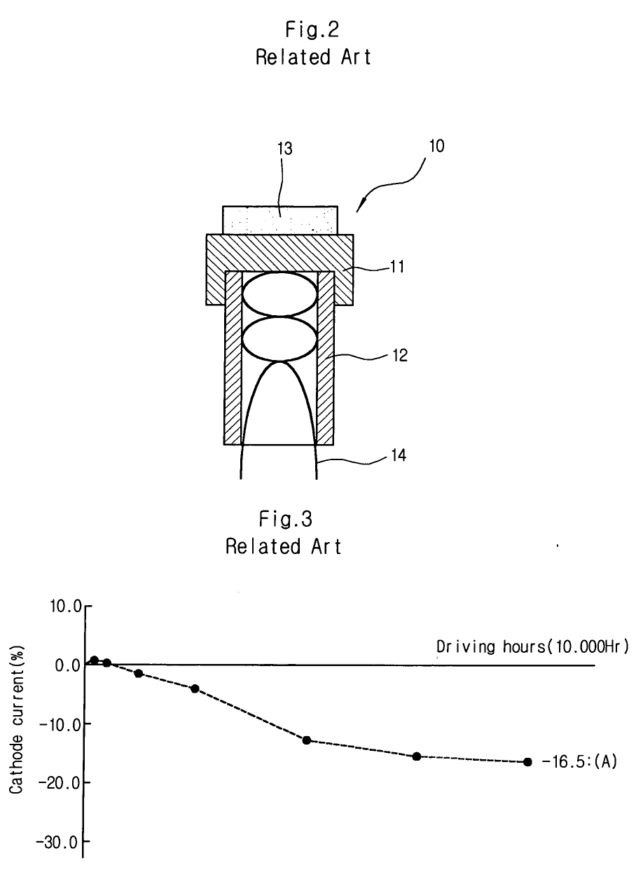

### DETAILED DESCRIPTION OF PREFERRED EMBODIMENTS

The following detailed description will present a cathode for a cathode ray tube according to a preferred embodiment of the invention in reference to the accompanying drawings.

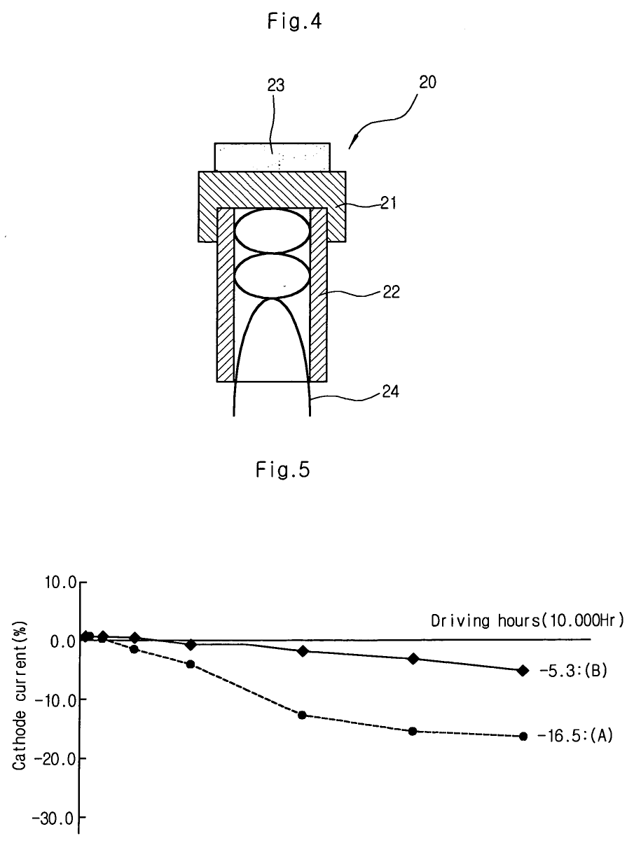

Referring to FIG. 4, the cathode for a cathode ray tube according to the present invention is composed of a base metal 21 having nickel (Ni) as a main ingredient, and an electron emitting material layer 23 containing an alkaline earth metal oxide with a barium oxide as a main ingredient.

The base metal 21 has nickel as a main ingredient, and further contains tungsten (W) and magnesium (Mg). The electron emitting material layer 23 further contains lanthanum (La) and nickel (Ni).

FIG. 5 is a graph comparing a life span of the cathode of the present invention to a life span of a related art cathode under a high current density.

More specifically, FIG. 5 illustrates measurements of cathode current reduction (in %) under a current density of 4.6 A/cm² for 10,000 hrs.

In FIG. 5, graph (A) shows cathode current of the related art cathode illustrated in FIG. 3, and graph (B) shows cathode current of the cathode according to the present invention.

The related art cathode is composed of a base metal containing Mg, Si, W and Ni, and an electron emitting material layer doped with La and Mg compounds. As seen on the graph (A), the related art cathode current shows 16.5% of decrease within 10,000 hrs, so it requires much improvement.

On the other hand, the cathode of the present invention, composed of a base metal containing W, Mg, and Ni, and an electron emitting material layer containing La and Ni with a barium oxide as a main ingredient, shows a 5.3% decrease in the cathode current within 10,000 hrs, which is 3.1 times less than that of the related art cathode.

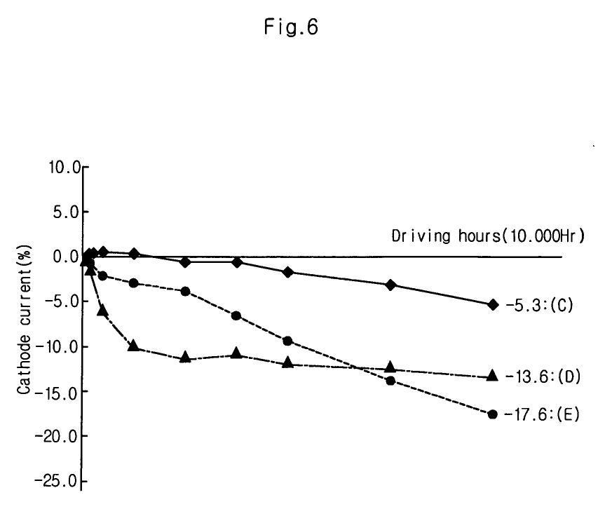

FIG. 6 graphically shows how a reducing metal doping onto the electron emitting material layer of a cathode affects life span of the cathode under a high current density.

In FIG. 6, graph (C) shows a life span test result of the cathode according to the present invention under a high current density, in which the base metal of the cathode has nickel (Ni) as a main ingredient and further contains one of highly diffusive reducing metals and one of reducing metals with a low diffusivity.

Graph (E) in FIG. 6 shows a life span test result of a related art cathode under a high current density, in which the base metal of the cathode has nickel (Ni) as a main ingredient and further contains two different kinds of reducing metals with a high diffusivity.

Graph (D) in FIG. 6 shows a life span test result of another related art cathode under a high current density, in which the base metal of the cathode has nickel (Ni) as a main ingredient and further contains two different kinds of reducing metals with a high diffusivity and one of reducing metals with a low diffusivity.

As for conditions of the life span test, current density of the cathode was set at 4.6 A/cm², and the test continued for 10,000 hrs. For the test, La and Ni were doped onto every electron emitting material layer sample.

Referring back to the graph (C) in. FIG. 6, the cathode of the present invention is composed of the base metal containing W, Mg, and Ni, and the electron emitting material layer containing La and Ni. According to the test result, the cathode current was reduced by 5.3% onlywithin 10,000 hrs.

Referring to the graph (E), the related art cathode is composed of the base metal containing Mg, Si, and Ni, and the electron emitting material layer containing La and Ni. According to the test result, the cathode current was reduced by 17.6% within 10,000 hrs, which is much higher than the current reduction rate of the present invention.

Referring to the graph (D), the related art cathode is composed of the base metal containing W, Mg, Al, and Ni, and the electron emitting material layer containing La and Ni. According to the test result, the cathode current was reduced by 13.6% within 10,000 hrs. Again the result is poor, compared to the current reduction rate of the present invention.

Before explaining an activation, <Table 1> below lists diffusion coefficients of different kinds of reducing metals included in the base metal having nickel as a main ingredient, which are measured at 1050°K, the activation temperature of an oxide cathode.

TABLE 1

| | Reducing metal | | | | | | | |
|---|---|---|---|---|---|---|---|---|
| | Zr | Mg | Si | Ti | Al | Mn | Mo | W |
| Diffusion | 300 | 71.5 | 21.6 | 14.0 | 8.74 | 7.9 | 1.34 | 0.112 |
| coefficient | | | | | | | | |
| (10⁻¹⁴ cm²/s) | | | | | | | | |

As discussed before, when a high-temperature activation process at about 900-1100° C. is performed, reducing metals included in the base metal 21 are diffused over the interface between the base metal 21 and the electron emitting material layer 23, and cause a chemical reaction with a part of the alkline earth metal oxide. As a result, the electron emitting material layer 23 obtains an electron emission capacity.

Depending on diffusion speed of the reducing metals included in the base metal 21, the chemical reaction with the alkaline earth metal oxide takes place in different rates, and the electron emitting material layer 23 emits electros for a long time.

To be more specific, magnesium, for example, which is a reducing metal with a high diffusion speed, affects an early stage of the life span, while tungsten, which is a reducing metal with a low diffusion speed, affects the lift span for hours.

In case of the related art cathode with a low current density, the reducing metals in the base metal relatively less reacted with the alkaline earth metal oxide. Thus a reducing metal with a low diffusion speed was not really needed because a reducing metal with a high diffusion speed was sufficient.

However, in case of the cathode with a high current density, a reducing metal with a low diffusion speed is absolutely needed as a reducing agent for an extended period of time.

Here, a reducing metal is said to have a high diffusion speed if diffusion coefficient thereof is greater than 5.0 (10 ⁻¹⁴cm²/s) at 1050°K, the activation temperature of the oxide cathode using the base metal that has nickel as a main ingredient. Under the same condition, when diffusion coefficient of a reducing metal is less 5.0 (10⁻¹⁴ cm²/s), the reducing metal is said to have a low diffusion speed.

For instance, zirconium (Zr), magnesium (Mg), silicon (Si), titanium (Ti), aluminum (Al), and Manganese (Mn) are categorized as reducing metals with a high diffusion speed. Molybdenum (Mo) and tungsten (W) are categorized as reducing metals with a low diffusion speed.

The graph (E) in FIG. 6 shows the life span test result of the related art cathode under the high current density, wherein the cathode uses the base metal containing only two different reducing metals with a high diffusion speed, namely Mg and Si. As shown on the graph, the cathode current is being continuously decreased with the passage of time.

This is because in a high current density, the alkaline earth metal oxide is reduced by the highly diffusive reducing metal with a short time, and in the absence of reducing metals with a low diffusion speed, it is not possible to reduce the alkaline earth metal oxide, an electron-emissive material, for a long time.

The graph (D) in FIG. 6 shows the life span test result of the related art cathode under the high current density, wherein the cathode uses the base metal containing two different reducing metals (i.e. Mg and Al) with a high diffusion speed, and one reducing metal with a low diffusion speed (i.e. W). The test result is similar to the one shown in the graph (A) of FIG. 3.

The related art cathode is characterized of containing two different kinds of reducing metals with a high diffusion speed. Therefore, the chemical reaction between the reducing metals with the alkaline earth metal oxide is predominant from the early stage of life span to the second stage, and during those stages, much of barium is evaporated, resulting in a rapid reduction of the cathode current.

In the meantime, the cathode of the present invention shown in the graph (C) uses the base metal containing nickel (Ni) as a main ingredient, and one of reducing metals with a high diffusion speed and one of reducing metals with a low diffusion speed. Here, magnesium is used as the highly diffusive reducing metal, and tungsten is used as the reducing metal with a low diffusion speed.

In a preferred embodiment of the present invention, the cathode 20 for the cathode ray tube of the invention contains 0.01-1.0 wt.% of the highly diffusive reducing metal, and 1.0-10 wt.% of the reducing metal with a low diffusion speed. This is because if the amount of the reducing metal with a low diffusion speed is too low, life span of the cathode is not much enhanced. On the other hand, if the amount of the highly diffusive reducing metal is too high, barium is easily evaporated and thus, the cathode current is rapidly reduced.

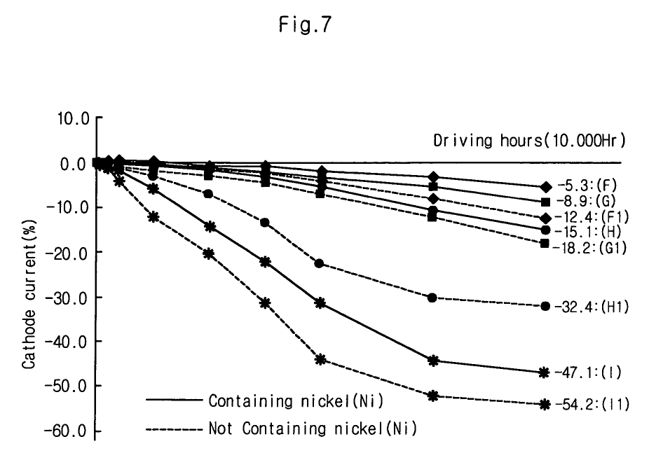

FIG. 7 graphically shows test results of life span of the cathode of the present invention, depending on kind of materials doped onto the electron emitting material layer of the cathode.

As for the test, the current density was set at 4.6 A/cm², and the test lasted for 10,000 hrs. Also, W, Mg, and Ni were included in everybase metal sample.

At first, graph (F) shows a test result obtained from the cathode composed of the base metal containing W, Mg, and Ni, and the electron emitting metal layer containing La and Ni. As shown on the graph (F), the cathode current was reduced only by 5.3% within 10,000 hrs.

Graph (F1) shows a test result obtained from the cathode composed of the base metal containing W, Mg, and Ni, and the electron emitting metal layer containing La. As shown on the graph (F1), the cathode current was reduced by 12.4% within 10,000 hrs.

Graph (G) shows a test result obtained from the cathode composed of the base metal containing W, Mg, and Ni, and the electron emitting metal layer containing Y and Ni. As shown on the graph (G), the cathode current was reduced by 8.9% within 10,000 hrs.

Graph (G1) shows a test result obtained from the cathode composed of the base metal containing W, Mg, and Ni, and the electron emitting metal layer containing Y. As shown on the graph (G1), the cathode current was reduced by 18.2% within 10,000 hrs.

Graph (H) shows a test result obtained from the cathode composed of the base metal containing W, Mg, and Ni, and the electron emitting metal layer containing Th and Ni. As shown on the graph (H), the cathode current was reduced by 15.1% within 10,000 hrs.

Graph (H1) shows a test result obtained from the cathode composed of the base metal containing W, Mg, and Ni, and the electron emitting metal layer containing Th. As shown on the graph (H1), the cathode current was reduced by 32.4% within 10,000 hrs.

Graph (I) shows a test result obtained from the cathode composed of the base metal containing W, Mg, and Ni, and the electron emitting metal layer containing Sc and Ni. As shown on the graph (I), the cathode current was reduced by 47.1% within 10,000 hrs.

Graph (I1) shows a test result obtained from the cathode composed of the base metal containing W, Mg, and Ni, and the electron emitting metal layer containing Sc. As shown on the graph (I1), the cathode current was reduced by 54.2% within 10,000 hrs.

It can be concluded from the life span test results under the high current density being set that the cathode current reduction rate is decreased when the electron emitting materials contains nickel (Ni), a conductive material.

The above phenomenon occurs because nickel enhances conductivity of the electron emissive alkaline earth metal oxide and prevents deterioration in melting the electron emitting materials caused by the high current density.

As for the conductive material to enhance conductivity of the electron emitting materials, besides nickel (Ni), one of tungsten (W), molybdenum (Mo), tantalum (Ta), and rhenium (Re) can be included to get even a better effect.

In addition, the effect can be stronger by forming the conductive materials in a needle shape in different diameters and lengths. In so doing, probability of superposition in the electron emitting material layer 23 can be increased.

Preferably, diameter of the conductive material should be 5 μm or less, and length of the conductive material should be 50 μm or less.

When the diameter of the conductive material is greater than 5 μm, weight of the conductive material in the electron emitting material layer 23 is increased, and in such case, it takes longer for activating the electron emitting material layer 23.

Also, suppose that the length of the conductive material is greater than 50 μm. What happens then when an alkaline earth metal oxide suspension is applied or coats a top surface of the base metal 21 by means of a spray gun, the suspension cannot pass through a nozzle of the spray gun, or is protruded outwardly from the electron emitting material layer 23.

Preferably, the conductive material for enhancing conductivity of the electron emitting material is in a range of 0.3 wt.% to 30 wt.% of the electron emitting material layer 23.

When the content of the conductive material is less than 0.3 wt.%, the probability of superposition thereof is lowered, while when the content of the conductive material is greater than 30 wt.%, it takes longer to activate the electron emitting material layer 23.

The best effect is obtained when nickel (Ni) and one of lanthanum (La), yttrium (Y), and thorium (Th) are contained in the electron emitting material as activating metals to activate the electron alkaline earth metal oxide.

The reason for the above is that the activating metals are used as a catalyst of the chemical reaction between the alkline earth metal oxide contained in the electron emitting material and the reducing metal(s) contained in the base metal, and they decompose a highly resistant intermediate product of the reaction.

Moreover, the activating metals are metallic compounds. In that way, they can be uniformly dispersed to the electron emitting material. Particularly, the activating metallic compound includes at least one functional group selected from acetate, acetonate, oxalate, and carbonate.

Preferably, the activating metals are 0.0003% to 15% by weight of the electron emitting material. When the weight of the activating metals is less than 0.0003% of the electron emitting material, life span of the cathode is hardly affected. However, when the weight of the activating metals is greater than 15% of the electron emitting material, it takes long to activate the electron emitting material.

From the experiment, it is found that a more desirable effect is obtained when the electron emitting material contains at least one of lanthanum (La), yttrium (Y), and thorium (Th) as the activating metal, and at least one of conductive materials selected from nickel (Ni), tungsten (W), molybdenum (Mo), tantalum (Ta), and rhenium (Re).

The effect gets strongest when lanthanum (La), which is an activating metal, and nickel (Ni), which is a conductive material, are contained in the electron emitting material.

The present invention is advantageously used to maintain life span of the cathode for an extended period of time, even under an extremely high current density of 4.6 (A/cm²).

Further, without using a very expensive impregnated cathode, the same effect can be obtained and thus, cost of manufacture of a cathode ray tube can be reduced.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A cathode for a cathode ray tube composed of a base metal and an electron emitting material layer containing an alkaline earth metal oxide having barium, wherein the base metal has nickel as a main ingredient and contains a reducing metal with a high diffusion speed and a reducing metal with a low diffusion speed; and the electron emitting material layer comprises activating metal(s).

2. The cathode according to claim 1, wherein the electron emitting material layer comprises a conductive material.

3. The cathode according to claim 1, wherein the activating metal(s) comprises at least one of lanthanum (La), yttrium (Y), and thorium (TH).

4. The cathode according to claim 2, wherein the conductive material comprises at least one of nickel (Ni), tungsten (W), molybdenum (Mo), tantalum (Ta), and rhenium (Rh).

5. The cathode according to claim 1, wherein the alkaline earth metal is strontium (Sr) or calcium (Ca).

6. The cathode according to claim 1, wherein the reducing metal with a high diffusion speed is a nickel-containing base metal of which activation temperature is 1050°K, and diffusion coefficient is greater than 5.0 (10⁻¹⁴ cm²/s).

7. The cathode according to claim 6, wherein the reducing metal with the high diffusion speed comprises at least one selected from a group consisting of zirconium (Zr), magnesium (Mg), silicon (Si), titanium (Ti), aluminum (Al), and Manganese (Mn).

8. The cathode according to claim 1, wherein the reducing metal with the high diffusion speed is contained in the base metal as much as 0.01-1.0% by weight.

9. The cathode according to claim 1, wherein the reducing metal with the low diffusion speed is a nickel-containing base metal of which activation temperature is 1050°K, and diffusion coefficient is less than 5.0 (10⁻¹⁴ cm²/s).

10. The cathode according to claim 9, wherein the reducing metal with the low diffusion speed comprises at least molybdenum (Mo) and tungsten (W).

11. The cathode according to claim 1, wherein the reducing metal with the high diffusion speed contained in the base metal amounts to 0.1-10% by weight.

12. The cathode according to claim 3, wherein the activating metal is contained in the electron emitting in a metal compound form.

13. The cathode according to claim 12, wherein the activating metal comprises at least one functional group selected from acetate, acetonate, oxalate, and carbonate.

14. The cathode according to claim 12, wherein the activating metal contained in the electron emitting material layer amounts to 0.0003-15% by weight.

15. The cathode according to claim 2, wherein the conductive material is in a needle shape in different diameters and lengths, to maximize conductivity of electron emissive materials.

16. The cathode according to claim 15, wherein the conductive material is 5 μm or less in diameter and 50 μm or less in length.

17. The cathode according to claim 2, wherein the conductive material contained in the electron emitting material layer amounts to 0.3-30% by weight.

18. The cathode according to claim 1, wherein the reducing metal with the high diffusion speed is magnesium (Mg), and the reducing metal with the low diffusion speed is tungsten (W).

19. The cathode according to claim 18, wherein the electron emitting material layer is doped with lanthanum (La) as an activating metal, and nickel (Ni) as a conductive material.

20. The cathode according to claim 1, wherein the electron emitting material layer is doped with lanthanum (La) as the activating metal, and nickel (Ni) as a conductive material.

21. A cathode for a cathode ray tube composed of a base metal and an electron emitting material layer, wherein the base metal has nickel as a main ingredient and contains a very small amount of a reducing metal; and the electron emitting material layer comprises a barium-containing alkaline earth metal oxide, at least one of activating metals, and at least one of conductive metals.

22. The cathode according to claim 21, wherein the activating metal comprises at least one of lanthanum (La), yttrium (Y), and thorium (Th).

23. The cathode according to claim 22, wherein the conductive material comprises at least one of nickel (Ni), tungsten (W), molybdenum (Mo), tantalum (Ta), and rhenium (Re).

24. The cathode according to claim 21, wherein the conductive material comprises at least one of nickel (Ni), tungsten (W), molybdenum (Mo), tantalum (Ta), and rhenium (Re).
